(19) United States
(12) Patent Application Publication
(10) Pub. No.: US 2026/0338199 A1
(43) Pub. Date: Oct. 29, 2026

(54) COMPRESSOR ARRANGEMENT FOR AN INTERNAL COMBUSTION ENGINE

(71) Applicant: Dr. Ing. h.c. F. Porsche Aktiengesellschaft, Stuttgart (DE)

(72) Inventors: Johannes Penner, Möckmühl (DE); Peter Wiese, Ditzingen (DE)

(73) Assignee: Dr. Ing. h.c. F. Porsche Aktiengesellschaft, Stuttgart (DE)

(21) Appl. No.: 19/657,136

(22) Filed: Apr. 24, 2026

(30) Foreign Application Priority Data
Apr. 29, 2025 (DE) 10 2025 116 498.3

(51) Int. Cl. F04D 29/44

(52) U.S. Cl. CPC F04D 29/444; F05D 2220/40; F05D 2240/126; F05D 2250/51

(57) ABSTRACT

A compressor assembly for an internal combustion engine, having a compressor impeller, a flow channel, which is arranged in the flow direction (SR) upstream of the compressor impeller, and a flow influencing device for influencing the flow through the flow channel. The flow influencing device includes an inner ring element, which divides the flow channel radially in sections into an outer ring channel and a central channel. A flow directing structure is arranged in the ring channel and is configured such that the flow resistance in the flow direction (SR) is less than in the reverse flow direction.

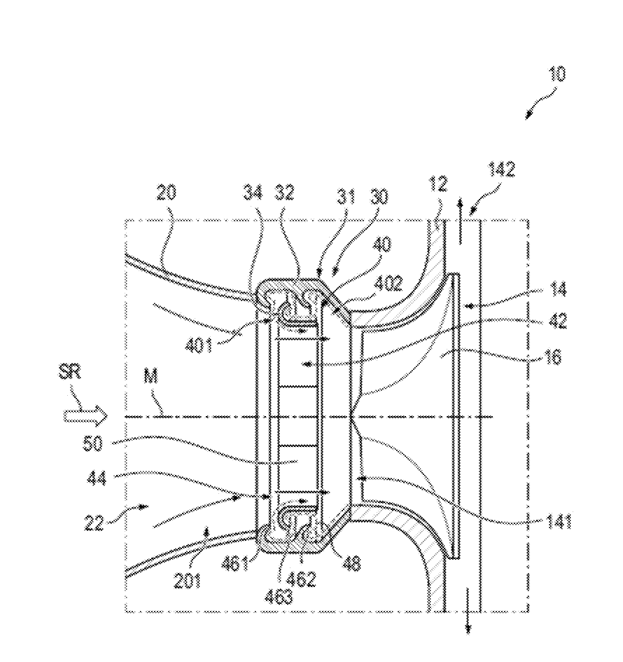

### CROSS REFERENCE TO RELATED APPLICATION

This application claims priority to German Patent Application No. 10 2025 116 498.3, filed Apr. 29, 2025, the content of such application being incorporated by reference herein in its entirety.

### FIELD OF THE INVENTION

The invention relates to a compressor assembly for an internal combustion engine having a compressor impeller, a flow channel arranged in the flow direction upstream of the compressor impeller, and a flow influencing device for influencing the flow through the flow channel, the flow influencing device comprising a ring element that radially divides the flow channel into an outer ring channel and a central channel in sections.

### BACKGROUND OF THE INVENTION

Such compressor assemblies may be known in the prior art, with the compressor assembly typically being operated with different mass air flows depending on the operating state of the internal combustion engine. It is problematic that, with reduced mass air flows to be conveyed by the compressor assembly, there is a risk of an unstable state of the compressor assembly. In a compressor map, the transition between the stable state and the unstable state is defined by a so-called surge limit. Once the surge limit is exceeded, so-called compressor surging occurs, such that at a certain pressure the minimum mass flow is undershot and the flow separates. If the mass air flow is too small, the inlet angle becomes so large that the flow separates at the blades of the compressor impeller. As a result, less momentum is transferred to the air, so that the mass air flow continues to decrease. As a result, the pressure difference between outlet and inlet cannot be maintained, thereby causing a reverse flow through the compressor assembly. In this case, the pressure ratio decreases, i.e., the boost pressure decreases, and the compressor assembly conveys again until the surge point is reached again. For example, this process occurs cyclically with a frequency of approximately 0.3–5 Hz and is associated with a typical sound.

In order to avoid such compressor surging, i.e., unstable operation, a surge limit control is usually provided, which is intended to prevent a certain minimum air mass flow from being undershot. This minimum air mass flow is to be understood as the respective pressure-dependent target value of the surge limit control and, in turn, forms the control line for surge prevention, which runs about 10% to the right of the surge limit in the characteristic map. When this control line is traversed, appropriate measures are initiated, whereby the mass air flow is increased again so that the operating point is kept at least on the control line.

Furthermore, it is desirable that high engine torques be achieved even at the lowest possible compressor mass flows, while still providing continuously increasing rated power. In turbocharged internal combustion engines in particular, the compressor must ensure high boost pressures, i.e., in the range of the surge limit, even at low air mass flows, and at the same time allow the high air mass flow at rated power with the required boost pressures.

EP 0 348 674 B1, which is incorporated by reference herein, discloses a stabilization measure for partial-load operation of the compressor assembly, wherein a ring element is rigidly arranged in an inflow flow channel in the flow direction upstream of the compressor impeller, which divides the flow channel into an outer ring channel and a central flow channel. A plurality of stabilizing vanes extend into the ring channel, which serve as a flow aid. By such a stabilization measure, stabilization in the range of the surge limit is achieved and thereby the original surge limit is stabilized, wherein operation is still only possible at higher compressor mass flows.

Is it noted that the statements appearing in the background section are not necessarily admitted prior art.

### SUMMARY OF THE INVENTION

Described herein is a compressor assembly for an internal combustion engine, in which a stable state can be ensured in a simple manner even at low mass air flows.

According to aspects of the invention, a flow-directing structure is arranged in the ring channel and is configured such that the flow resistance for the air flowing through the ring channel is lower in the flow direction than in the reverse-flow direction, i.e., opposite to the flow direction. The flow direction is the direction in which air flows during normal operation of the compressor assembly. In other words, the air is drawn in by a rotating compressor wheel and thus flows in the flow direction toward the compressor wheel. Accordingly, in the reverse-flow direction, the air flows away from the compressor wheel into the flow channel.

By configuring the flow-directing structure such that, depending on the flow direction of the air flowing through the ring channel, the flow resistance differs, it is achieved that, for example, at higher air mass flows, for example in full-load operation of the compressor assembly, the air flowing in the flow direction, which may also flow through the ring channel, is not, or not significantly, influenced by the flow-directing structure. If air flows through the ring channel in the reverse-flow direction, i.e., opposite to the flow direction, the flow resistance is so high that such a reverse flow through the ring channel is impeded, thereby reducing the risk of reverse flow.

Due to the low flow resistance in the flow direction, the compressor assembly can be operated at higher air mass flows with high efficiency. The increased flow resistance in the reverse-flow direction can significantly reduce reverse flow during operation of the compressor assembly with low air mass flows. Rather, the surge limit is shifted toward lower compressor mass flows, whereby high engine torques can be provided at low air mass flows without compressor surge occurring.

Preferably, the flow-directing structure comprises a plurality of ribs projecting into the ring channel and extending transversely to the flow direction, wherein the ribs are arranged in a labyrinth-like manner relative to one another and form an angle with the central axis of the flow channel that is less than 90°. The ribs arranged transversely to the flow direction, which are also arranged obliquely toward the compressor impeller, form a pocket or reverse-flow trap, wherein air flowing in the reverse-flow direction, i.e., air flowing opposite to the flow direction, flows into the pockets or reverse-flow trap and is strongly braked or backed up. This causes a relatively high flow resistance in the reverse-flow direction. Otherwise, the obliquely arranged ribs act differently for airflow in the flow direction, wherein the oblique ribs do not create any pockets or reverse-flow traps, and the ribs, if anything, cause a slight, insignificant deflection of the airflow.

In a preferred embodiment, the ribs have a hook-like shape. This can improve the effect of a reverse-flow trap.

Preferably, two outer ribs are arranged on an outer peripheral surface radially delimiting the ring channel and an inner rib is arranged on an inner peripheral surface radially delimiting the ring channel, wherein the inner rib is arranged in the flow direction between the two outer ribs. The reverse flow usually occurs due to a swirl in the circumferential direction and, due to the resulting centrifugal forces, in an outer region. A first outer rib, which is arranged closest to the compressor impeller, causes a first deflection of the reverse flow in the flow direction and radially inward toward the inner rib, at which the airflow is deflected in the flow direction and radially outward toward the second outer rib, at which the air is in turn deflected in the flow direction and radially inward. Thus, the air flowing in the reverse-flow direction is deflected multiple times, i.e., in a stepwise manner, in the flow direction, thereby causing braking of the reverse flow.

In a preferred embodiment, the ring channel has an inlet and an outlet, wherein the outlet opens upstream of a compressor chamber in the flow direction. Because the outlet of the ring channel is arranged upstream of the compressor chamber in the direction of flow, the inlet angle of the compressor wheel is not affected, so the properties of the compressor assembly are not negatively affected by the formation of the ring channel. Alternatively, the outlet opens into a compressor chamber in the direction of flow such that the inflow direction of an air flow passing through the ring channel deviates from the inflow direction of the air flow through the central channel.

In a preferred configuration, an inner peripheral surface of the ring element is arranged radially aligned with a flow channel portion which delimits the flow channel upstream and/or downstream of the ring element in the flow direction. This does not affect the air flow through the ring channel, since the ring channel is hardly traversed by air at all in normal operation, i.e., when no reverse flow is present. Alternatively, the inner ring element projects radially into the flow channel, whereby the effect of the reverse flow trap can be increased.

Preferably, at least one longitudinal rib extending in the flow direction is arranged in the ring channel and extends radially from the inner peripheral surface to the outer peripheral surface of the ring channel. The reverse flow is so strongly swirled that the reverse flow has a tangential movement component. By means of the longitudinal rib, the air flow is redirected in the reverse-flow direction such that the tangential movement component is converted into a movement component in the reverse-flow direction, thereby increasing the effect of the reverse-flow trap.

In a preferred configuration, the flow influencing device comprises a flow influencing unit having an inner ring element and an outer ring element, wherein the inner ring element is radially surrounded by the outer ring element such that the two ring elements bound the ring channel, wherein the flow influencing unit is mounted between a flow channel element and a compressor housing. The reverse-flow trap can thus be realized without having to modify a flow channel element and the compressor housing.

Preferably, the inner ring element and the outer ring element are connected to each other by the longitudinal ribs. Thus, no additional components are required to connect the ring elements to each other.

Preferably, the ring element comprises a plurality of guide vanes on an inner peripheral surface. The vanes serve to redirect the air flow to adjust the inlet angle of the compressor impeller such that a higher efficiency of the compressor assembly can be provided. Preferably, the guide vanes are formed integrally with the ring element.

The compressor assembly is a component of an exhaust turbocharger, which also has a turbine impeller that is connected to the compressor impeller in a torque-transmitting manner by a turbocharger shaft. Alternatively, the compressor assembly may be a separate, standalone unit, for example, an electrically driven compressor.

### BRIEF DESCRIPTION OF THE DRAWING FIGURE

An exemplary embodiment of the invention is explained in further detail with reference to the drawing.

The figure schematically illustrates a compressor assembly in longitudinal section.

### DETAILED DESCRIPTION OF THE INVENTION

The figure discloses a compressor assembly 10 of an exhaust turbocharger of an internal combustion engine.

The compressor assembly 10 includes a compressor housing 12 that defines a compressor chamber 14, the compressor chamber 14 having an inlet 141 and an outlet 142. A compressor impeller 16 is arranged in the compressor chamber 14 and is rotatably supported. In particular, the compressor impeller 16 is non-rotatably connected to a turbocharger shaft (not shown), to which a turbine impeller (not shown) is also fastened.

The compressor assembly 10 further includes a flow channel element 20 that defines a flow channel 22, and a flow influencing device 30, the flow influencing device 30 being arranged in the flow direction between the compressor housing 12 and the flow channel element 20.

The flow influencing device 30 comprises a flow influencing unit 31 inserted between the flow channel element 20 and the compressor housing 12. The flow influencing device 30 or the flow influencing unit 31 comprises an outer ring element 32 and an inner ring element 34. The inner ring element 34 radially defines a central channel 42 with an inner peripheral surface. The inner ring element 34 also radially defines a ring channel 40, which has an inlet 401 and an outlet 402, together with an inner peripheral surface of the outer ring element 32, via an outer peripheral surface. When viewed in the flow direction SR, the outlet 402 of the ring channel 40 is arranged upstream of the inlet 141, so that the air flowing through the ring channel 40 also flows toward the compressor impeller 16 at a substantially the same inlet angle as the air flowing through the central channel 42. The inner peripheral surface of the inner ring element 34 is substantially aligned with an inner peripheral surface of the flow channel element 20.

A flow directing structure 44 is arranged in the ring channel 40. The flow directing structure 44 comprises three hook-shaped ribs 461, 462, 463 projecting into the ring channel 40, with two outer ribs 461, 462 arranged on the outer ring element 32 and an inner rib 463 arranged on the inner ring element 34. The inner rib 463 arranged on the inner ring element 34 is arranged in the flow direction SR between the two outer ribs 461, 462 such that the ribs 461, 462, 463 are arranged in a labyrinth-like manner relative to one another. The hook-shaped ribs 461, 462, 463 are oriented and configured such that a mass air flow flowing in the reverse-flow direction is deflected by each rib 461, 462, 463 in the flow direction SR.

In the ring channel 40, a plurality of longitudinal ribs 48 are also arranged, spaced apart from one another in the circumferential direction and extending in the flow direction SR, which extend radially from the inner peripheral surface to the outer peripheral surface of the ring channel 40. The longitudinal ribs 48 serve, on the one hand, to connect the two ring elements 32, 34 so that the inner ring element 34 is fastened to the outer ring element 32, and, on the other hand, to align the flow through the ring channel 40 such that a tangential flow component is reduced and thereby the swirl of the air mass flow flowing through the ring channel 40 is reduced.

The inner ring element 34 additionally comprises a plurality of guide vanes 50 distributed around the inner peripheral surface, through which the air flowing through the central channel 42 is redirected, whereby the efficiency of the compressor assembly 10 can be increased at high air mass flows.

By means of such a flow influencing device 30 and the specially configured flow directing structure 44, the flow resistance of the air flowing through the ring channel 40 differs depending on the flow direction SR. In this case, the air flowing in the reverse flow direction is strongly redirected and significantly slowed, whereas the air flowing in the flow direction SR, which may also flow through the ring channel, is not, or not substantially, influenced by the flow influencing device 30.

Due to the low flow resistance in the flow direction SR, the compressor assembly 10 can be operated at higher air mass flows with high efficiency. The increased flow resistance in the reverse-flow direction significantly reduces reverse flow during operation of the compressor assembly 10 with low air mass flows. The key point is that the surge limit is shifted toward lower compressor mass flows, whereby high engine torques can be provided at low air mass flows without compressor surge occurring.

What is claimed is:

1. A compressor assembly for an internal combustion engine, said compressor assembly comprising:
a compressor impeller,
a flow channel arranged in a flow direction (SR) upstream of the compressor impeller,
a flow influencing device configured to influence a flow through the flow channel, wherein the flow influencing device comprises an inner ring element, wherein the inner ring element divides the flow channel radially in sections into an outer ring channel and a central channel, and
a flow directing structure arranged in the outer ring channel and configured such that a flow resistance in the flow direction (SR) is less than in a reverse flow direction that is opposite to the flow direction (SR).

2. The compressor assembly according to claim 1, wherein the flow directing structure comprises a plurality of ribs projecting into the outer ring channel and extending transversely to the flow direction (SR), wherein the ribs are arranged in a labyrinth-like manner relative to one another and form an angle with a central axis (M) of the flow channel that is less than 90°.

3. The compressor assembly according to claim 2, wherein each rib has a hook shape.

4. The compressor assembly according to claim 2, wherein two outer ribs of the plurality of ribs are arranged on an outer peripheral surface radially delimiting the outer ring channel and wherein an inner rib of the plurality of ribs is arranged on an inner peripheral surface radially delimiting the outer ring channel, wherein the inner rib is arranged in the flow direction (SR) between the two outer ribs.

5. The compressor assembly according to claim 1, wherein the ring channel comprises an inlet and an outlet, wherein the outlet opens into the flow channel in the flow direction (SR) upstream of a compressor chamber.

6. The compressor assembly according to claim 1, wherein the outer ring channel comprises an inlet and an outlet, wherein the outlet opens in the flow direction (SR) into a compressor chamber.

7. The compressor assembly according to claim 1, wherein an inner circumferential surface of the inner ring element is arranged radially aligned with a flow channel section that radially delimits the flow channel (SR) upstream and/or downstream of the inner ring element in the flow direction (SR).

8. The compressor assembly according to claim 1, wherein the inner ring element projects radially into the flow channel (SR).

9. The compressor assembly according to claim 1, further comprising at least one longitudinal rib that extends in the flow direction (SR), is arranged in the outer ring channel and extends radially from an inner peripheral surface to an outer peripheral surface of the outer ring channel.

10. The compressor assembly according to claim 1, wherein the flow influencing device comprises a flow influencing unit that comprises the inner ring element and an outer ring element, the inner ring element being radially surrounded by the outer ring element such that the inner and outer ring elements delimit the outer ring channel, the flow influencing unit being mounted between a flow channel element and a compressor housing.

11. The compressor assembly according to claim 10, further comprising at least one longitudinal rib that extends in the flow direction (SR), is arranged in the outer ring channel and extends radially from an inner peripheral surface to an outer peripheral surface of the outer ring channel, wherein the inner ring element and the outer ring element are connected to one another by the at least one longitudinal rib.

12. The compressor assembly according to claim 1, wherein the inner ring element comprises, on an inner peripheral surface, a plurality of guide vanes projecting into the central channel.

13. An internal combustion engine comprising the compressor assembly according to claim 1.

14. A vehicle comprising the internal combustion engine according to claim 13.
